(19) United States
(12) Patent Application Publication
(10) Pub. No.: US 2012/0127833 A1
(43) Pub. Date: May 24, 2012

(54) ACOUSTIC POWER AND DATA TRANSMISSION THROUGH A SOLID MEDIUM

(75) Inventors: Ronald David Ghen, Fairfax Station, VA (US); George Edward Anderson, JR., Barrington, RI (US); Michael Richard Strong, Warrenton, VA (US); Michael Edward Mullen, Lewisberry, PA (US)

(73) Assignee: PROGENY SYSTEMS CORPORATION, Manassas, VA (US)

(21) Appl. No.: 12/950,468

(22) Filed: Nov. 19, 2010

(51) Int. Cl. H04B 1/02

(52) U.S. Cl. 367/137

(57) ABSTRACT

A system for transmitting power and data through a solid medium includes a power signal transmitter configured to acoustically transmit power through the solid medium to a power signal receiver using a first frequency and a data signal transmitter configured to acoustically transmit data through the solid medium to a data signal receiver using a second frequency. The second frequency may be offset from the first frequency and from at least a first overtone of the first frequency. Furthermore, the data signal transmitter and data signal receiver may be positioned at a null of a pattern of acoustic waves produced by operation of the power signal transmitter. The system may further include a notch filter coupled to receive an electrical output of the data signal receiver, the notch filter being tuned to attenuate the first frequency.

This invention was made with government support under Contract Numbers N00024-06-C-4131 and N65538-05-M-0203 awarded by the Navy. The Government has certain rights in the invention.

### BACKGROUND

Data is typically transmitted from one location to another using electrical or optical signals, either wirelessly or using electrical or optical cables. Power is also typically transmitted through wires. However, use of a cable or electromagnetic radiation to transfer power or data is impractical in certain situations. For example, a submarine is typically equipped with sensors, e.g., acoustic hydrophones, on an outboard side of its steel hull that collect environmental parameters for various purposes, such as mapping an underwater terrain. Such sensors require a large, steady supply of power. Moreover, the collected data must typically be analyzed in near real-time by operators within the submarine. The current method for getting the power to and signals from these sensors requires creating a hole (i.e., hull penetration) in the submarine's wall for passage of a wire. However, submarine hull penetration compromises the structural integrity of the submarine hull, and is prohibitively costly to make and maintain. Use of alternative methods such as electromagnetic signals is not viable as these signals cannot penetrate the submarine's steel hull. Other containers or devices having steel barriers or the like (e.g., chemical or fuel tanks, nuclear reactors, armored vehicles, munitions, etc.) suffer drawbacks similar to or the same as those outlined above with respect to submarines.

### SUMMARY

In general, embodiments of the proposed invention relate to methods and systems for transmitting signals via acoustic energy. In particular, the methods and systems operate to transmit power and data signals via acoustic energy through a solid medium, such as a steel wall.

A first general aspect of the invention is a system for transmitting power and data through a solid medium. The system includes: a first power signal transmitter configured to acoustically transmit power through the solid medium to a first power signal receiver using a first frequency and a first data signal transmitter configured to acoustically transmit data through the solid medium to a first data signal receiver using a second frequency. In one embodiment, the second frequency is offset from the first frequency and from at least a first overtone of the first frequency.

In another embodiment, the data signal transmitter and data signal receiver are positioned at a null of a pattern of acoustic waves produced by operation of the power signal transmitter.

In another embodiment, the acoustic power and data transmission system further includes a notch filter coupled to receive an electrical output of the data signal receiver, the notch filter being tuned to attenuate the first frequency.

In another embodiment, the acoustic power and data transmission system further includes a second power signal transmitter configured to acoustically transmit power through the solid medium to a second power signal receiver using the first frequency.

In another embodiment, the acoustic power and data transmission system further includes a second data signal transmitter configured to acoustically transmit data through the solid medium to a second data signal receiver using a third frequency. The third frequency is offset from the first and second frequencies and from a first overtone of at least one of the first and second frequencies.

In another embodiment, the acoustic power and data transmission system further includes a data modulator configured to modulate a data signal onto a carrier signal using a keying modulation scheme at a rate of one bit per carrier cycle and to couple the modulated carrier signal to the data signal transmitter for transmission through the solid medium.

In another embodiment, the solid medium is a wall of a vessel having a structural framing element and the first power signal transmitter and first power signal receiver are positioned on a first side of the structural framing element and the first data signal transmitter and first data signal receiver are positioned on a second side opposite the first side of the structural framing element.

In another embodiment, the acoustic power and data transmission system further includes a power cable coupled to supply at least some of the power transmitted through the solid medium from the first power signal receiver to the first data signal transmitter.

In another embodiment, the acoustic power and data transmission system further includes a sensor communicatively coupled to the first data signal transmitter. The sensor is configured to sense an environmental parameter and to provide the sensed environmental parameter to the first data signal transmitter coupled thereto for transmission through the solid medium to the first data signal receiver.

A second general aspect of the invention is a system for transmitting power through a solid medium. The system includes: a power signal transmitter configured to acoustically transmit power through the solid medium to a power signal receiver and a controller configured to adjust an operating frequency of an ultrasonic power signal transmitted by the power signal transmitter to reduce transmission loss through the solid medium.

In one embodiment, the controller is configured to repeatedly adjust the operating frequency during operation of the system to maintain the operating frequency at a frequency that minimizes transmission loss through the solid medium.

In another embodiment, the acoustic power transmission system further includes a power supply configured to supply electrical power to the power signal transmitter and a circuit configured to measure a level of power drawn from the power supply and to provide the power level measurement to the controller. The controller is configured to adjust the operating frequency based on the power level measurement. For example, the controller may adjust the operating frequency if the power measurement indicates the level of power drawn is not at a minimum level.

In another embodiment, the controller is configured to adjust an amplitude of the transmitted ultrasonic power signal based on a level of power drawn from the power signal receiver.

A third general aspect of the invention is a method for transmitting power through a solid medium. The method includes: transmitting an ultrasonic power signal through the solid medium; measuring efficiency of transmission of the ultrasonic power signal frequency; and based on the efficiency measurement, adjusting a frequency of the ultrasonic power signal transmitted through the solid medium to reduce transmission loss through the solid medium.

In one embodiment, the method for transmitting power through a solid medium further includes repeating the measurement of transmission efficiency and adjustment of the operating frequency during operation of the system to maintain the operating frequency at a frequency that minimizes transmission loss through the solid medium.

In another embodiment, measuring efficiency of the ultrasonic power signal frequency includes measuring a level of power drawn by a power amplifier that drives transmission of the ultrasonic power signal. The operating frequency may be adjusted if the power measurement indicates the level of power drawn is not at a minimum level.

In another embodiment, the method for transmitting power through a solid medium further includes adjusting the amplitude of the transmitted ultrasonic power signal based on a level of power drawn from a power signal receiver that receives the ultrasonic power signal.

Additional features of the invention will be set forth in the description which follows, and in part will be obvious from the description, or may be learned by the practice of the invention. The features of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 shows an example system for acoustically transmitting power and data through a solid medium;

FIG. 2 shows a power spectral density graph scaled to show overtones of a power signal transmitted through the solid medium of the system of FIG. 1;

FIG. 3 shows a location of a data signal receiver relative to a power signal transmitter of the system of FIG. 1 and a standing wave pattern of acoustic energy generated by the power signal transmitter;

FIG. 4 shows a data signal transmitting and receiving portion of the example system of FIG. 1;

FIG. 5 shows a power signal transmitting and receiving portion of the example system of FIG. 1;

FIG. 6 shows a power spectral density graph scaled to show a resonant operating frequency of a power signal transmitted through the solid medium of the system of FIG. 1;

FIG. 7 shows an alternative embodiment of a power signal transmitting and receiving portion of the system of FIG. 1;

FIG. 8 shows the structure of an example split electrode transducer in the power signal transmitter of the alternative embodiment of FIG. 7; and

FIG. 9 shows an example method for transmitting power through a solid medium.

### DETAILED DESCRIPTION

Reference will now be made to the figures wherein like structures will be provided with like reference designations. It is understood that the figures are diagrammatic and schematic representations of presently preferred embodiments of the invention, and are not limiting of the present invention, nor are they necessarily drawn to scale.

Embodiments of systems and methods described herein provide, among other things, high-speed communications and/or efficient power transmission through a solid medium, such as an HY80 alloy steel wall of a submarine hull. An example system includes at least one power signal transducer pair and at least one data signal transducer pair.

A power signal communicated by the power signal transducer pair produces undesirable interference with successful communication of a data signal by the data signal transducer pair. Operational frequencies of the transducer pairs are selected to inhibit such interference. The location of the data signal transducer pair relative to the power signal transducer pair is also selected to inhibit such interference. Moreover, a notch filter tuned to the operational frequency of the power signal transducer pair attenuates the power signal at the data signal receiving transducer, thereby inhibiting interference caused by the power signal. Furthermore, efficiency of power transmission through the solid medium is improved by adjusting the operating frequency of the power signal transmitting transducer in response to environmental changes that affect a resonant frequency of the assemblage of components through which the power signal is transmitted. Using these and other inventive techniques described in more detail below, the example system is able to achieve high speeds of ultrasonic data communication through a solid medium while efficiently transmitting high levels of power through the solid medium.

I. System Overview

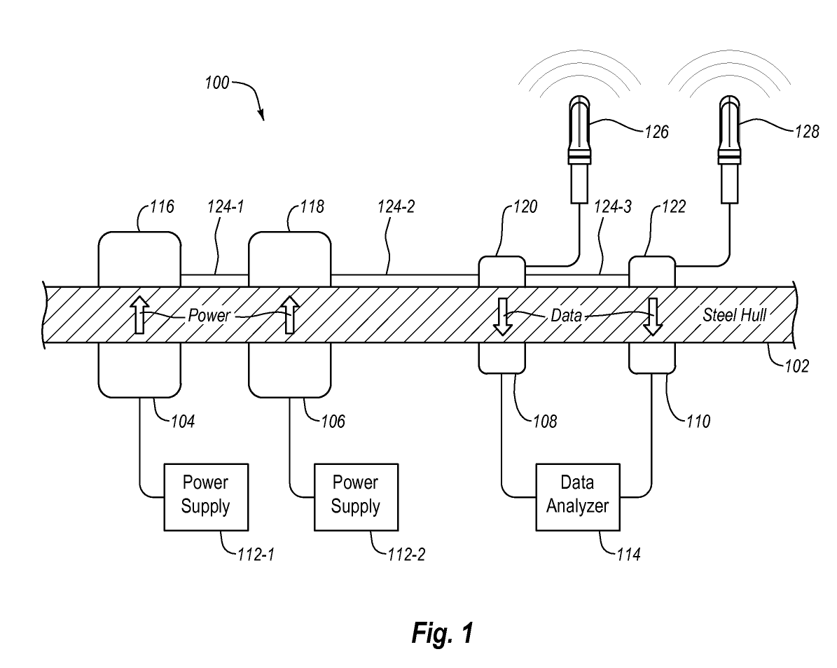

FIG. 1 shows a functional block diagram of an example system 100 for use in a submarine, which is just one of various example environments in which system 100 is applicable. It will be appreciated by those of ordinary skill in the art that system 100 can be adapted for use in other environments having a steel barrier or the like through which power and/or data must pass, including other containers or vessels (e.g., chemical or fuel tanks, nuclear reactors, armored vehicles, munitions, etc.).

System 100 includes elements on an inboard side of a submarine hull 102 and elements on an outboard side of submarine hull 102. Inboard elements include first and second power signal transmitters 104 and 106 and first and second data signal receivers 108 and 110. Power supply assemblies 112-1, 112-2 supply an electric power signal at a maximally efficient frequency to drive power signal transmitters 104 and 106, respectively. A data analyzer 114 receives, processes, and displays data received by data signal receivers 108 and 110. In one embodiment, data analyzer 114 includes or is connected to a keyboard to receive data queries from an operator. Moreover, data analyzer 114 may provide direct current power to inboard elements, such as data signal receivers 108 and 110.

Outboard elements include first and second power signal receivers 116 and 118, positioned directly opposite first and second power signal transmitters 104 and 106, respectively, to receive power signals transmitted acoustically through hull 102. Outboard elements also include first and second data signal transmitters 120 and 122, positioned directly opposite first and second data signal receivers 108 and 110, respectively, to transmit ultrasonic data signals acoustically through hull 102. Power is supplied to first and second data signal transmitters 120 and 122 by first and second power signal receivers 116 and 118 via one or more cables 124. The data carried by the ultrasonic data signals is generated by sensors, such as hydrophones 126 and 128, which are coupled, respectively, to first and second data signal transmitters 120 and 122. Outboard elements are secured to hull 102 with suitable fasteners and/or a marine epoxy, such as versathane.

Transducers with piezoelectric elements, also referred to herein after as ‘piezo elements,’ are included in each power and data signal transmitter and receiver. Transducers in the power and data signal transmitters convert an electric signal to an ultrasonic signal and transmit the ultrasonic signal. Transducers in the power and data signal receivers perform an opposite operation, i.e. they convert a received ultrasonic signal to an electric signal. Those skilled in the art will realize that the piezo elements could be replaced with magnetostrictive elements, electroacoustic elements, electromagnetic-mechanical drivers or other electrical/mechanical transducers, as appropriate, in certain applications.

The electric power signals supplied by power supply assemblies 112-1, 112-2 are at a resonant frequency determined at least in part by the inboard to outboard thickness of submarine hull 102. Moreover, to minimize losses due to attenuation through the solid medium, the operating frequency is selected to be relatively low, e.g., in a range of about 25 kHz to about 5 MHz when steel is the solid medium through which power is transmitted. Power supply assemblies 112-1, 112-2 can be individual power supplies dedicated for use with a corresponding one of first and second power signal transmitters 104 and 106 (as shown) or, as an alternative, system 100 may include a single power supply assembly that supplies power signals to multiple power signal transmitters. If separate power supplies are used, each power signal transmitter may be driven with a different operating frequency or with substantially the same operating frequency.

By driving power signal transmitters 104 and 106 with a resonant frequency signal, efficiency of power transfer is maximized or, in other words, transmission loss through the solid medium is minimized. However, even a slight drift away from the resonant frequency can severely decrease efficiency. Thus, power supply assemblies 112-1, 112-2 may each include a controller that adapts the frequency of the power signal to maintain resonance and, therefore, efficient power transfer. An example controller and its frequency control function, as well as an optional amplitude control function, are described in greater detail below in the subsection entitled, “Power Signal Transmitter/Receiver Pair.”

Cables 124 allow for various different circuit configurations. For example, in the depicted arrangement, cable 124-1 couples first power signal receiver 116 to second power signal receiver 118 in either a series or parallel connection, cable 124-2 couples power from first and/or second power signal receivers 116 and 118 to first and second data signal transmitters 120 and 122, and cable 124-3 couples first data signal transmitter 120 to second data signal transmitter 122 in either a series or parallel connection. Moreover, cables that couple data from hydrophones 126, 128 may also couple power from data signal transmitters 120, 122 to hydrophones 126, 128, respectively. Alternatively, a cable may extend from each of first and second power signal receivers 116 and 118 to a rechargeable battery (not shown) housed in any one of elements 116, 118, 120, and 122, or in a separate dedicated housing, and a cable may extend from the rechargeable battery to each data signal transmitter and to each hydrophone to supply power. In addition, portions of cables 124 that extend outside of transmitter/receiver housings may be secured to submarine hull 102 by suitable fasteners and/or a marine epoxy, such as versathane.

System 100 is only one example configuration of elements for transmitting and receiving power and data acoustically through a solid medium, such as hull 102. Those skilled in the art will appreciate that other configurations of system 100 may include any number of power signal transmitter and receiver pairs and any number of data signal transmitter and receiver pairs including, for example, only a single power signal transmitter and receiver pair and/or only a single data signal transmitter and receiver pair. In some applications, e.g., where data rate requirements are comparatively low, power and data signals can be communicated using a single transmitter and receiver pair. In such applications, data and power signals can be transferred at separate times. Alternatively, the data and power signals can be transferred simultaneously, e.g., by modulating data on an out-of-band overtone of the power signal. Moreover, the single transmitter and receiver pair can be selectively configurable to transmit data and/or power signals in either direction. In addition, all or a portion of the transmitters and receivers on the same side of hull 102 may be housed together in a single housing. A single housing for multiple transmitters and/or receivers provides a predetermined spacing between the transmitters/receivers housed therein, thereby reducing installation time and expense.

Furthermore, although communication of data is shown as flowing from outboard transmitters to inboard receivers in parallel, data may flow in both directions in parallel or sequentially. For example, one or both of the depicted data signal transmitter/receiver pairs may be capable of bidirectional data communications. Thus, one or both of data signal transmitters 120 and 122 may be equipped with appropriate data signal receiver circuitry and data signal receivers 108 and 110 may be equipped with appropriate data signal transmitter circuitry. Moreover, each bidirectional data signal transceiver on the outboard side may be equipped to receive configuration commands sent from an operator inside the submarine via a data signal transmitter/receiver pair dedicated for inboard to outboard data communications. Accordingly, each bidirectional data signal transceiver on the outboard side can be selectively configured as a transmitter or a receiver based on the configuration commands. Alternatively, one of the data signal transmitter/receiver pairs is dedicated to the function of transmitting data in an inboard direction while the other of the data signal transmitter/receiver pairs is dedicated to the function of transmitting data in an outboard direction.

As noted above, system 100 can be adapted for use in other environments or with other containers or vessels, such as chemical tanks, nuclear reactors, armored vehicles, and munitions, having a rigid, solid, continuous, barrier made of a material, such as metal, through which electromagnetic signals cannot easily pass. When implemented in such other environments, other sensors or data systems may be used in place of hydrophones 126 and 128. For example, when system 100 is implemented in a fuel tank, a fuel level sensor inside the fuel tank may collect data about a fuel level and the collected data is transmitted ultrasonically to a data signal receiver on the outside of the fuel tank. Moreover, the fuel level sensor and data signal transmitter inside the fuel tank may receive power through a power signal transmitted ultrasonically through the fuel tank wall using a power signal transmitter and receiver pair as described above. System 100 may also be used to implement a computer network in which a barrier prevents passage of wires or electromagnetic signals in the network. In such a computer network implementation, a computer or data analyzer like data analyzer 114 is used in place of or in addition to hydrophones 126 and 128 (or other sensors) and the data signal transmitter and receiver pairs implement bidirectional data communications, as described above.

In some alternative embodiments, an operator may wish to send data to (as opposed to receive data from) a location that is electromagnetically shielded by a container wall. For example, an operator of a craft (e.g., a submarine, aircraft, land vehicle, etc.) carrying missiles or other munitions may wish to program a missile with its origin location, a target location or identifier, and/or other instructions. Wired communications with the missile require use of a quick-release connection that is often difficult to maintain and has been found to be unreliable. Moreover, electromagnetic communications are impractical because the missile is typically located in a canister or other container that blocks electromagnetic signals and the memory device on which the instructions are to be stored is located within the missile, whose outer casing also blocks electromagnetic signals. System 100 can be implemented at one or both electromagnetic barriers (i.e., at the canister wall and at the missile casing wall) to provide a convenient and reliable communication channel between the operator and the missile. Moreover, because some missiles have their own source of power, power signal transmitter and receiver pairs may optionally be omitted from the missile casing wall.

A more detailed description of an example data signal transmitter/receiver pair is provided immediately below. Following the description of the example data signal transmitter/receiver pair is a more detailed description of an example power signal transmitter/receiver pair.

II. Data Signal Transmitter/Receiver Pair

First data signal transmitter 120 and first data signal receiver 108 can be said to form a first data signal transmitter/receiver pair. Similarly, second data signal transmitter 122 and second data signal receiver 110 can be said to form a second data signal transmitter/receiver pair. Thus, the following description of an example data signal transmitter/receiver pair is applicable to both the first and second data signal transmitter/receiver pairs in system 100 and to any other optionally included data signal transmitter/receiver pairs in alternative embodiments of system 100.

An example data signal transmitter includes a piezoelectric transducer that converts an electrical signal to an ultrasonic signal. In addition, the example data signal transmitter may be equipped to receive and convert an optical signal into an electrical signal, which the piezoelectric transducer then converts to an ultrasonic signal. The example data signal transmitter may also include circuitry that supports transmission of the ultrasonic signal, such as analog to digital and digital to analog converters, digital signal modulator, error correction encoder, signal amplifier, impedance matching network, etc. Some or all of the support circuitry may be implemented in a circuit card assembly that includes an ultrasonic modem module.

An example data signal receiver similarly includes a piezoelectric transducer that converts an ultrasonic signal to an electrical signal. Optionally, the electrical signal may then be converted to an optical signal. The example data signal receiver may also include circuitry that supports reception of the ultrasonic signal, such as, an impedance matching network, notch filter, signal amplifier, digital signal demodulator, error correction decoder, analog to digital converter, etc. As with the data signal transmitter, some or all of the support circuitry for the data signal receiver may be implemented in a circuit card assembly that includes an ultrasonic modem module.

In one embodiment, multiple data signal transmitters are housed together in a single integral housing that has a cable coupling each transmitting piezoelectric transducer in the housing to a single circuit card assembly. Similarly, data signal receivers corresponding to the data signal transmitters may be housed together in a single integral housing that has a cable coupling each receiving piezoelectric transducer in the housing to a single circuit card assembly. Alternatively, a housing on the inboard side may house one or more data signal transmitters and one or more data signal receivers with a cable coupling each transmitting and receiving piezoelectric transducer to a single circuit card assembly. A similar housing with both transmitter(s) and receiver(s) may be on the outboard side. Moreover, in some or all of the forgoing multiple data signal transmitter/receiver housings the single circuit card assembly may be replaced with multiple circuit card assemblies each of which is dedicated for use with a single corresponding piezoelectric transducer.

In the interest of conserving space and power, a data signal transmitter/receiver pair is located in proximity to power signal transmitter/receiver pair(s) and, in certain embodiments, in proximity to other data signal transmitter/receiver pairs. The proximity to other transmitter/receiver pairs introduces undesirable interference when the transmitter/receiver pairs operate simultaneously, which limits a rate at which data can be transmitted acoustically through hull 102. Aspects of system 100 described below remedy or counteract such interference, thereby enabling communication at high data rates while high levels of power are transmitted through hull 102.

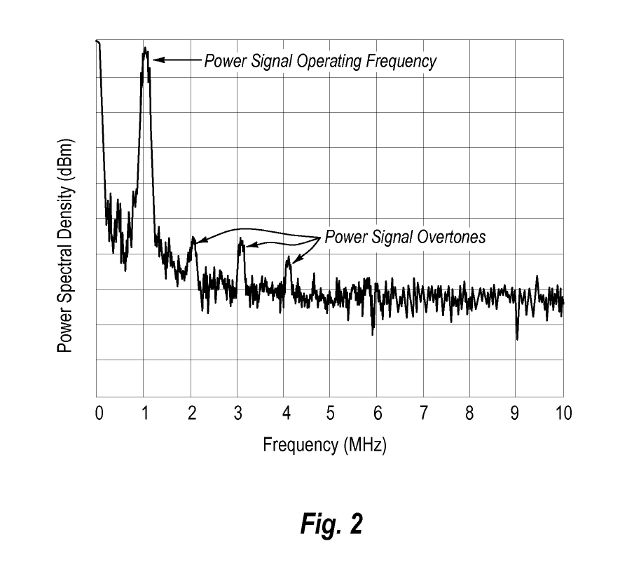

According to one aspect that enables high data rates and high levels of power transmission, a frequency that carries data communications is offset from a frequency that carries power and from one or more overtones of the power signal frequency. FIG. 2 depicts a power spectral density graph of a power signal, such as one transmitted by one of power signal transmitters 104 and 106 of FIG. 1. The vertical axis represents power and the horizontal axis represents frequency. As shown in the graph of FIG. 2, the power signal's operating frequency has the highest power density, while significant power density spikes naturally occur at overtones of the power signal operating frequency. To reduce the undesirable effects of interference from the power signal and its overtones, a data signal transmitter/receiver pair operating in proximity to a power signal transmitter is configured to operate at a frequency that is offset from the power signal's operating frequency and from one or more overtones of the power signal's operating frequency. For example, if the power signal operating frequency is 1 MHz, the data signal's operating frequency can be selected to be within the range of about 5 MHz to 15 MHz to avoid interference with the comparatively stronger 1 MHz power signal and some of its most significant overtones, i.e., at 2 MHz, 3 MHz, and 4 MHz. Strategically selecting a data signal frequency to avoid interference with the power signal frequency reduces channel interference and cross-talk, thereby permitting an increased data rate, all else being equal.

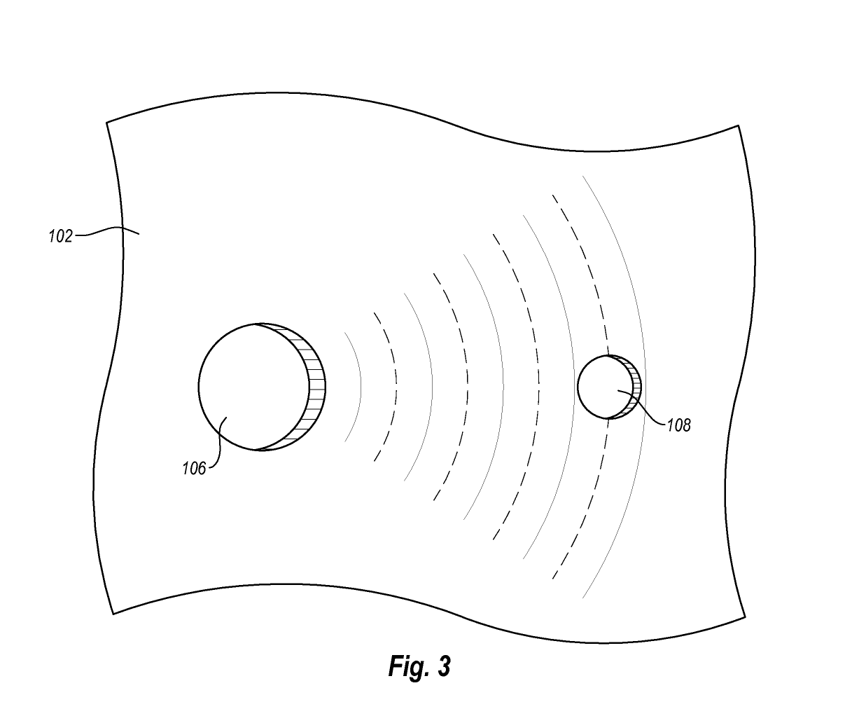

Another aspect that enables an increased data rate and power transmission is the location of the data signal transmitter/receiver pair(s) relative to the location of the power signal transmitter/receiver pair(s). As shown in FIG. 3, data signal receiver 108 and a corresponding data signal transmitter (not shown) are positioned at a null of a pattern of acoustic waves produced by operation of nearby power signal transmitter 106. The acoustic waves emanate away from power signal transmitter 106 and include regions where acoustic waves constructively interfere (i.e., peaks/troughs), represented by unbroken lines, and regions where acoustic waves destructively interfere (i.e., nulls), represented by broken lines. (For simplicity, the peaks/troughs and nulls are depicted in FIG. 3 as having a circular pattern but in practice the pattern will often be more complex due to reflections of acoustic energy within hull 102 and from nearby framing elements of hull 102.) By positioning data signal receiver 108 at a null or point of destructive interference in the pattern of acoustic waves, an overall size of system 100 is minimized while interference from the power signal is also minimized, thereby increasing the rate of data transmission and/or decreasing the data signal transmission power needed to overcome interference due to the power signal.

Although FIG. 3 shows a single power signal transmitter and a single data signal receiver, multiple power signal transmitters and multiple data signal receivers may be present and positioned in accordance with the foregoing principles. For example, multiple data signal receivers may be positioned in a ring (or partial ring) pattern around a single power signal transmitter in correspondence with a ring pattern of nulls in the pattern of acoustic waves around the power signal transmitter. Moreover, if more than one power signal transmitter is present, a data signal receiver may be positioned at a null in the pattern of acoustic waves produced by superposition of acoustic waves from all the power signal transmitters. Alternatively, if more than one power signal transmitter is present, data signal receiver(s) may be positioned at nulls in a pattern of acoustic waves produced by operation of a nearest one of the power signal transmitters while the acoustic waves of other power signal transmitter(s) are ignored due to their more attenuated effect.

A submarine hull typically includes internal structural elements, such as frames or ribs, that lend structural support to the hull. Such structural elements also provide some attenuation to power signals. Therefore, when system 100 is implemented in a submarine or similar context in which structural elements are present, the interfering effects of a power signal can be reduced by positioning data signal transmitter and receiver pairs on a first side of a structural element and positioning power signal transmitter and receiver pairs on a second, opposite side of the structural element.

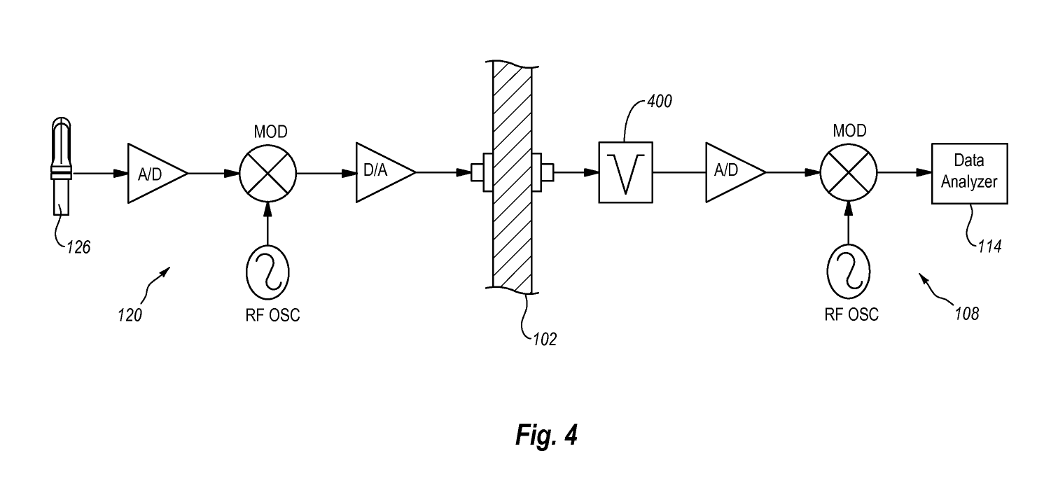

The power signal will typically be of larger amplitude compared to the data signal and can therefore overdrive or saturate the data signal receiver even if the foregoing measures are taken. Therefore, a notch filter may also be included in or coupled to each data signal receiver to suppress the power signal frequency at each data signal receiver. FIG. 4 shows a functional block diagram of a data signal transmitter and receiver pair 120, 108 in which data signal receiver 108 includes or is coupled to a notch filter 400. Notch filter 400 may be implemented as a simple LC circuit interposed between a transducer of data signal receiver 108 and a demodulator of data signal receiver 108. Notch filter 400 is selectively tuned to filter out the frequency of a power signal, thereby mitigating the interfering effect of the power signal on one or more data signals transmitted simultaneously with the power signal.

Any one of or a combination of the foregoing techniques may be applied to improve a data rate. Alternatively or in addition to improving a data rate, a data signal power level may be reduced. Data may be modulated onto an ultrasonic data signal using any suitable modulation scheme. In one example implementation, data is modulated using a keying modulation scheme at a rate of one bit per clock cycle. For example, data can be modulated onto the ultrasonic data signal using on/off keying or bi-phase shift keying. Moreover, in some embodiments, the modulated data may include error correction coding to reduce a bit error rate.

III. Power Signal Transmitter/Receiver Pair

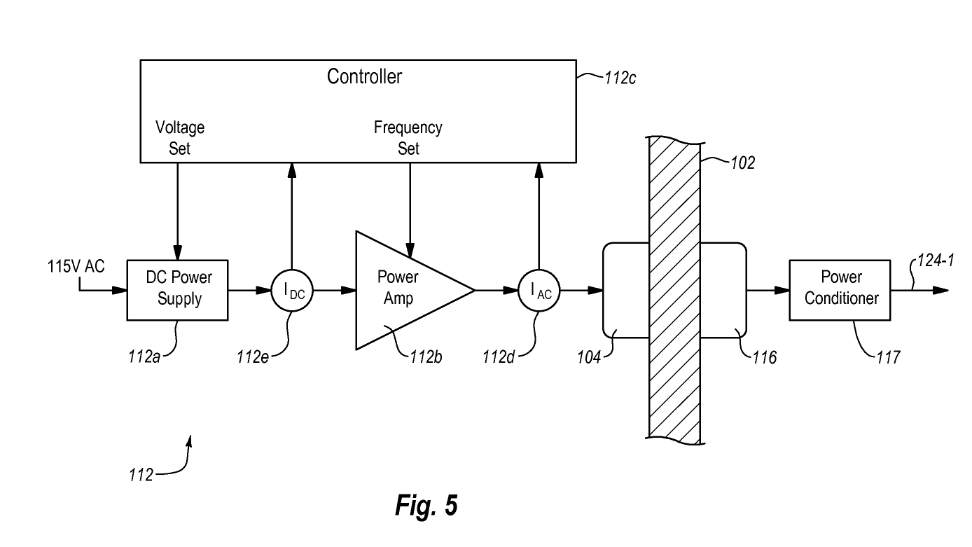

FIG. 5 shows a functional block diagram of power signal transmitter 104, power signal receiver 116 and supporting components. Although only a single power signal transmitter/receiver pair is depicted in FIG. 5 and described below, the description is applicable to both the first and second power signal transmitter/receiver pairs in system 100.

From end to end, system 100 is at least about 12% to 20% efficient at delivering power ultrasonically to the outboard side of hull 102 from an external power source on the inboard side of hull 102. Beginning at a left-most end of FIG. 5, power supply assembly 112 derives power from an external power source, such as a 115 volt alternating current (AC) wall socket. Power supply assembly 112 may draw, for example, 118 watts from the external power source.

Power supply assembly 112 includes a direct current (DC) power supply 112a, a power amplifier 112b, and a controller 112c that sets a voltage level of a DC power signal output by power supply 112a and sets an operating frequency of power amplifier 112b. The efficiency of DC power supply 112a is about 85% in one embodiment, resulting in a supply of up to about 100 watts to amplifier 112b. The power transmission efficiency of amplifier 112b may be about 85%, corresponding to a supply of up to about 85 watts to power signal transmitter 104.

The efficiency of power transfer through hull 102 is as high as about 30% to about 40% when amplifier 112b is operated at a resonant frequency of the assemblage of power signal transmitter 104, hull 102, and power signal receiver 116. Thus, a supply of up to about 21 watts is provided from power signal receiver 116 to a power conditioner 117, which may be housed in power signal receiver 116 or may be provided with a separate housing external to power signal receiver 116. Power conditioner 117 conditions the power signal for use by one or more outboard components, such as data signal transmitters 120 and 122. The efficiency of power conditioner 117 may be about 70% and therefore power conditioner 117 may supply about 15 watts to the outboard components.

An alternating current (AC) ammeter 112d may optionally be interposed between power amplifier 112b and power signal transmitter 104 to report a current measurement to controller 112c. Controller 112c may use AC current measurements to detect when an undesirable operating condition occurs in amplifier 112b. If an undesirable operating condition is detected, controller 112c changes the operating frequency.

Amplifier 112b may be a single stage or a multi-stage power amplifier capable of receiving a signal and outputting an amplified version of the signal. By way of example, and not limitation, amplifier 112b may be a resonant Class E amplifier. An operating frequency of amplifier 112b is selected by controller 112c via a “frequency set” command generated by controller 112c. For example, a voltage controlled oscillator may be included in or coupled to amplifier 112b and may vary the frequency of its output signal, which is amplified by amplifier 112b, based on the “frequency set” command from controller 112c.

To maintain high efficiency of power transmission, an initial operating frequency of the voltage controlled oscillator is selected in dependence on a resonant frequency of the assemblage of power signal transmitter 104, hull 102, and power signal receiver 116. The resonant frequency of an acoustic medium, such as the assemblage of power signal transmitter 104, hull 102, and power signal receiver 116, depends on the type of materials from which the acoustic medium is made and the thickness of the acoustic medium. For example, when the acoustic medium includes a steel hull that is about 1.8 inches thick, the initial operating frequency is selected to be at or around 1 MHz.

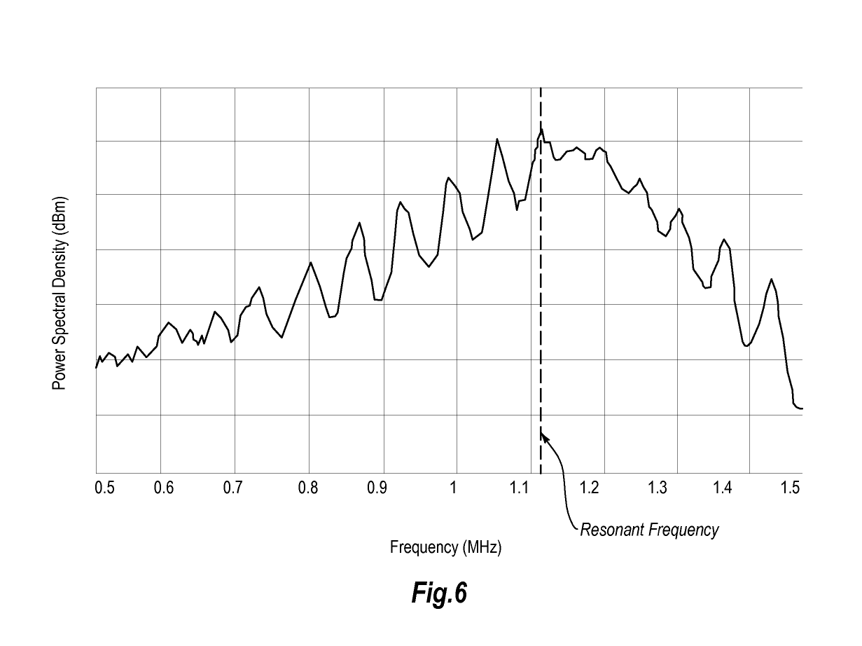

FIG. 6 shows a power spectral density graph of a power signal received by power signal receiver 116 through a steel hull about 1.8 inches thick. As shown by the graph, the acoustic assemblage has a peak resonant frequency at around 1.1 MHz and has periodically repeating harmonics of the resonant frequency both above and below the resonant frequency. However, as shown by the graph, a slight variance away from the peak resonant frequency can result in a significant drop in power transmission efficiency.

An initial or “home” operating frequency may be selected while manufacturing or installing system 100. Various factors may be taken into account when selecting a home operating frequency. In the case of a military submarine, the home operating frequency may be chosen to be high enough such that any unintended “leakage” of acoustic power at that frequency into the surrounding seawater is attenuated strongly, such as in excess of −100 dB per kilometer, such that a stealth aspect of the submarine is not compromised. But in all application fields, other, more fundamental decision factors also apply when selecting a home operating frequency. For example, a transducer in power signal transmitter 104 may have a slightly different resonant frequency than a transducer in power signal receiver 116 due to variations in manufacturing and bonding of the transducers to hull 102. If this were the only consideration, a frequency halfway between the two transducers' resonant frequencies could be selected as the home operating frequency. Another factor to take into account, however, is the thickness of hull 102 through which acoustic power is to be transmitted. Ideally, an integer number of half-wavelengths of the operating frequency should fit within the thickness of hull 102 (where the “thickness” dimension extends from the transmitting transducer to the receiving transducer). Thus, for example, nine half-wavelengths of a 0.985 MHz signal will span the thickness of a hull that is 1.8 inches (45.72 mm) thick, whereas ten half-wavelengths of a 1.094 MHz signal will span a hull of the same thickness. In between these two frequencies, a non-integer number of half-wavelengths would span the hull thickness, resulting in less than optimal resonance. An exact thickness of hull 102 is often unknown or difficult to measure due to incidental physical variations. Moreover, the effective acoustic thickness can vary due to factors such as a layer of glue between a transducer and hull 102. However, scanning the frequency up or down by at most 110 kHz (i.e, the difference between 1.094 MHz and 0.985 MHz) can be performed to find an optimally resonant frequency.

To improve accuracy, a search for the home operating frequency may be performed after power signal transmitter 104 and power signal receiver 116 are warmed up. For example, a dummy load may be coupled to draw about one third a maximum level of power from power signal receiver 116 until a temperature of the power signal transducers reaches a steady state (e.g., about 10 minutes). After manually optimizing the operating frequency for resonance, an installer can program controller 112c (or a memory accessible to controller 112c) with the selected home operating frequency to use as a starting point when searching for a maximally efficient or resonant operating frequency.

The maximally efficient operating frequency may vary from the home operating frequency due to changes in the operational environment of system 100, such as different temperatures, different levels of pressure, and different electrical loads. For example, changes in temperature and changes in the electrical load placed on (or current drawn from) power signal receiver 116 can affect the elastic constant of a transmit piezo element in power signal transmitter 104 and/or a receive piezo element in power signal receiver 116. If a piezo element's elastic constant changes due to temperature and/or load changes, the piezo element's resonant operating frequency will also change. Environmental temperature changes can also cause some degree of expansion or contraction in hull 102, shifting the hull's ideal resonant frequency. Changes in depth of submersion of hull 102 will also shift the hull's ideal resonant frequency because a change in pressure effectively changes one or more elastic constants of the material of hull 102 and hence the speed of sound travelling through hull 102. Due to the anticipated environmental and load changes, controller 112c includes control circuitry and/or software that dynamically and automatically controls the frequency of the voltage controlled oscillator to maintain operation of amplifier 112b at an optimally resonant frequency.

Control of the frequency is performed based on a measurement of power transfer efficiency through hull 102. Power transfer efficiency is ideally measured by comparing a ratio of power out to power in. However, a proxy of this ideal measurement can be used instead. For example, one method of control may be based on a feedback signal provided by a DC ammeter 112e interposed between DC power supply 112a and power amplifier 112b. Empirical measurements have shown a negative correlative relationship between an amount of power drawn from DC power supply 112a and the maximally efficient operating frequency. The amount of power drawn at the maximally efficient operating frequency is minimized because at the maximally efficient operating frequency the alternating voltage and current of the power signal output by power amplifier 112b are substantially in phase. When the voltage and current are out of phase, power amplifier 112b draws more power due to increased heat loss. Therefore, DC ammeter 112e provides controller 112c with a measurement of current drawn from DC power supply 112a. This measurement may be sampled repeatedly while controller 112c searches for an optimally resonant operating frequency. The search may be performed by automatically stepping the operating frequency up and/or down with increasingly fine step sizes until the current drawn from DC power supply 112a reaches a local minimum. To maintain an optimum operating frequency, current levels may be periodically evaluated at regular or semi-regular intervals during operation of system 100 and the operating frequency may be recalibrated if necessary based on the periodic current measurements. To save processing time and power, a frequency recalibration may be performed more frequently when (or only when) a sufficiently significant change in the environment (e.g., temperature change, electrical load change, or pressure change) is sensed.

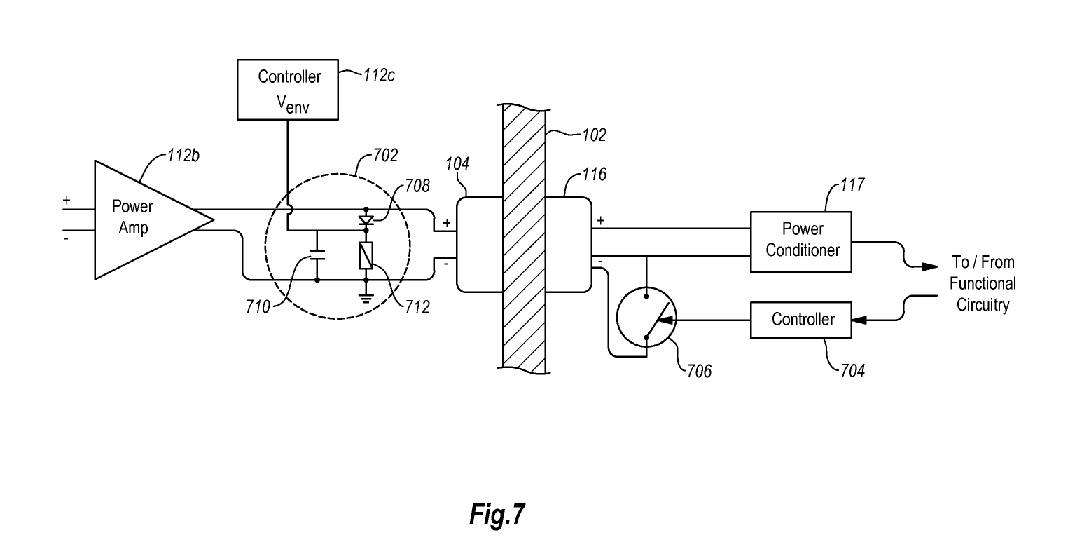

FIG. 7 depicts an alternative embodiment of system 100. In the alternative embodiment of FIG. 7, another feedback path is used to control the operating frequency of power amplifier 112b. Thus, DC ammeter 112e may be omitted in the embodiment of FIG. 7 and a voltage envelope meter 702 and a controller 704 may be included instead. Voltage envelope meter 702, located between power amplifier 112b and power signal transmitter 104, may be housed in power signal transmitter 104, power amplifier 112b, or may be provided with a separate housing. Similarly, controller 704, located on the outboard side of hull 102, may be housed in power signal receiver 116 or may be provided with a separate housing. Controller 704 transmits a feedback signal that is detected at voltage envelope meter 702. Thus, in conveying the feedback signal through hull 102, power signal receiver 116 serves as a data signal transmitter and power signal transmitter 104 serves as a data signal receiver.

First, a level of power received by power signal receiver 116 may be measured by a power level detector (not shown, but located, for example, between power signal receiver 116 and power conditioner 117 or between power conditioner 117 and functional circuitry that receives power from power conditioner 117). Controller 704 receives the power level measurement and modulates a switch 706 (e.g., a field effect transistor switch) connected across electrodes of the transducer in power signal receiver 116 to communicate the sensed power level data. The level of power measured by the power level detector provides an indication of how efficiently power is being transferred and, therefore, an indication of whether the operating frequency of power amplifier 112b should be adjusted.

An output of voltage envelope meter 702 will fluctuate in correspondence with modulation of switch 706. Thus, controller 112c, which reads the output of voltage envelope meter 702, can detect the feedback signal generated by controller 704. The feedback signal may carry digitally encoded commands or data that controller 112c is programmed to recognize. For example, the feedback signal may carry digitally encoded data representing the sensed power level. Controller 112c is programmed to decode the digitally encoded data and process the data to determine whether to increase or decrease the operating frequency. Alternatively, controller 704 on the outboard side of hull 102 may be programmed to perform processing on power level measurements, in which case the feedback signal may carry digitally encoded commands including, for example, a first string of bits representing a command to increase the operating frequency or a second string of bits representing a command to decrease the operating frequency.

Envelope voltage meter 702 includes a diode 708, a capacitor 710, and a high impedance element 712 (e.g., a resistor). A first end of diode 708 is connected to a power signal line output from power amplifier 112b and a second end is connected to capacitor 710 and high impedance element 712, which are connected in parallel from diode 708 to a ground line. Only a small amount of current is drawn by voltage envelope meter 702 due to the high impedance of high impedance element 712. Diode 708 and capacitor 710 work in conjunction to provide a voltage envelope measurement of the AC signal on the power signal line.

The alternative feedback path from the outboard side to inboard side of hull 102 may be implemented as an alternative to or in addition to use of current measurements to control frequency. Moreover, other data may be transmitted via the feedback path from controller 704 to controller 112c. Such other data may include, for example, diagnostic/health measurements related to circuitry and software running on the outboard side of hull 102, and/or commands for power signal transmitter 104 to increase or decrease an amplitude of the transmitted power signal, including a command to reduce the amplitude to zero (i.e., off) to conserve energy. Furthermore, a similar communication channel may be implemented for sending housekeeping data, diagnostic data, and commands in the opposite direction, i.e., from controller 112c to controller 704, with another one of switch 706 coupled to power signal transmitter 104 and another one of voltage envelope meter 702 coupled to power signal receiver 116.

Another feedback path from the outboard side of hull 102 may be implemented using one or more data signal transmitter/receiver pairs, such as data signal transmitter 120 and data signal receiver 108 and/or data signal transmitter 122 and data signal receiver 110. In this alternative embodiment, both power and feedback information are electrically transmitted via cables from one or more power signal receivers to one or more data signal transmitters. The power in the power signal is used to power the data signal transmitters and the feedback information in the data signals is transmitted acoustically to the other side of hull 102 where it is forwarded to controller 112c for controlling the power signal operating frequency or for other purposes, as discussed above.

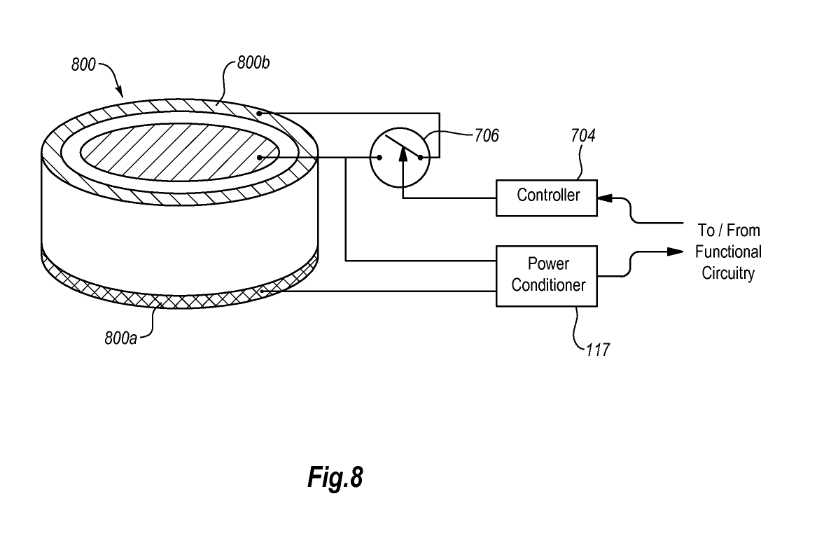

FIG. 8 depicts a conceptual diagram of an example transducer 800 that may be used in power signal receiver 116 to provide a communication channel to power signal transmitter 104. Transducer 800 has a bottom electrode 800a and a top electrode 800b. Top electrode 800b is split into an outer ring-shaped portion and an inner circular-shaped portion. Switch 706 may be connected across the split portions of top electrode 800b.

As discussed above with reference to FIG. 7, controller 704 communicates a signal to the other side of hull 102 by modulating switch 706, which results in an impedance change detectable by voltage envelope meter 702. For example, in a default state in which controller 704 transmits nothing, switch 706 is closed and top electrode 800b is similar in size to bottom electrode 800a, thereby enabling transducer 800 to optimally convert the acoustic power signal from power signal transmitter 104 into an electric power signal. On the other hand, when transmitting data, controller 704 causes switch 706 to repeatedly open for small amounts of time. When switch 706 is open, the outer ring-shaped portion of top electrode 800b floats and top electrode 800b is momentarily smaller than bottom electrode 800a, which momentarily reduces the efficiency of converting acoustic power to electric power. However, the momentary opening of switch 706 also results in an impedance change detectable by voltage envelope meter 702, thereby communicating data to controller 112c.

IV. Example Method

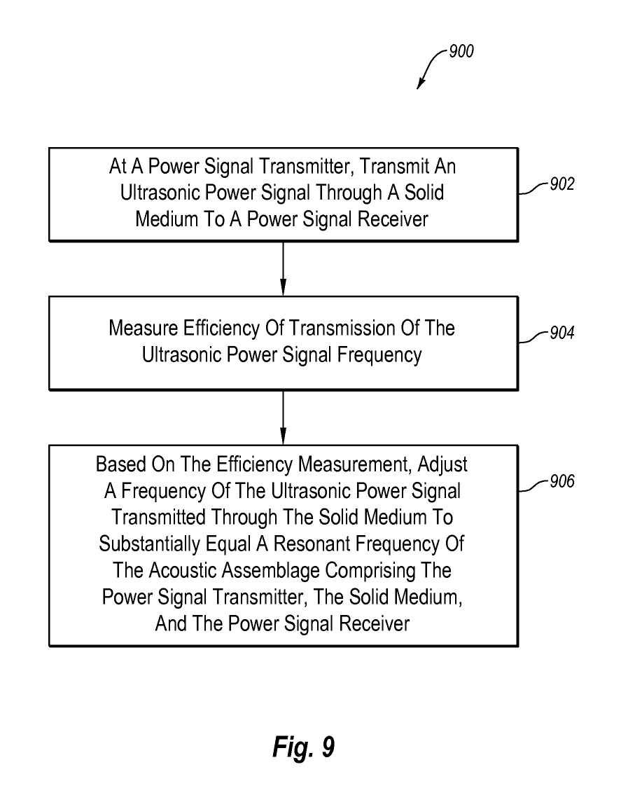

FIG. 9 shows an example method 900 for controlling frequency of a power signal transmitted by one of power signal transmitters 104 and 106. Method 900 may be implemented by one or more processors, such as controller 112c in system 100, using computer-executable instructions stored on computer-readable media accessible to the one or more processors. In method 900 a power signal transmitter begins transmitting an ultrasonic power signal through a solid medium (e.g., a submarine hull) to a power signal receiver on the other side of the solid medium (stage 902). A measurement of transmission efficiency is then made (stage 904). Based on the measurement of transmission efficiency, a controller adjusts the frequency of the ultrasonic power signal to substantially equal a resonant frequency of the acoustic assemblage comprising the power signal transmitter, the solid medium, and the power signal receiver (stage 906). Adjustment of the operating frequency and measurement of transmission efficiency is repeated during operation of the system to maintain the operating frequency at the resonant frequency.

The transmission efficiency may be measured in various ways. For example, a DC ammeter may measure a level of power drawn by a power amplifier that drives the power signal transmitter. The operating frequency is adjusted if the power level measurement indicates the level of power drawn is not at a minimum level.

Alternatively, transmission efficiency may be measured by a power level detector on the power signal receiving side of the solid medium. The power level measured by the power level detector may be communicated to the controller on the power signal transmission side using a switch coupled to the power signal receiver and a voltage envelope meter coupled to the power signal transmitter, as discussed above in reference to FIGS. 7 and 8. An amount of power drawn by the functional circuitry on the power signal receiving side of the solid medium may also be communicated along this feedback path and the controller may adjust an amplitude of the transmitted ultrasonic power signal accordingly.

V. Computer Hardware and/or Software Implementations

Embodiments described herein may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media including recordable-type storage media. Computer-readable media that carry computer-executable instructions are transmission media. Thus, by way of example, and not limitation, embodiments of the invention can comprise at least two distinctly different kinds of computer-readable media: non-transitory physical storage media and transmission media.

Non-transitory physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmission media can include a network and/or data links which can be used to carry or transport desired program code means in the form of computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to non-transitory physical storage media. For example, computer-executable instructions or data structures received over a network or data link can be buffered in RAM within a network interface card, and then eventually transferred to computer system RAM and/or to less volatile physical storage media at a computer system. Thus, it should be understood that non-transitory physical storage media can be included in computer system components that also (or even primarily) utilize transmission media.

Computer-executable instructions comprise, for example, instructions and data which cause a general purpose computer, special purpose computer, or special purpose processing device or controller to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The foregoing detailed description of various embodiments is provided by way of example and not limitation. Accordingly, the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for transmitting power and data through a solid medium, the system comprising:
a first power signal transmitter configured to acoustically transmit power through the solid medium to a first power signal receiver using a first frequency; and
a first data signal transmitter configured to acoustically transmit data through the solid medium to a first data signal receiver using a second frequency, the second frequency being offset from the first frequency and from at least a first overtone of the first frequency.

2. The system of claim 1, wherein the first data signal transmitter and first data signal receiver are positioned at a null of a pattern of acoustic waves produced by operation of the first power signal transmitter.

3. The system of claim 1, further comprising a notch filter coupled to receive an electrical output of the first data signal receiver, the notch filter being tuned to attenuate the first frequency.

4. The system of claim 1, further comprising a second power signal transmitter configured to acoustically transmit power through the solid medium to a second power signal receiver using the first frequency.

5. The system of claim 1, further comprising a second data signal transmitter configured to acoustically transmit data through the solid medium to a second data signal receiver using a third frequency, the third frequency being offset from the first and second frequencies and from a first overtone of at least one of the first and second frequencies.

6. The system of claim 1, further comprising a data modulator configured to modulate a data signal onto a carrier signal using a keying modulation scheme at a rate of one bit per carrier cycle and to couple the modulated carrier signal to the data signal transmitter for transmission through the solid medium.

7. The system of claim 1, wherein the first frequency is about 1 MHz and the second frequency is in a range of about 8 MHz to about 20 MHz.

8. The system of claim 1, wherein the solid medium is a wall of a vessel having a structural framing element, and wherein the first power signal transmitter and first power signal receiver are positioned on a first side of the structural framing element and the first data signal transmitter and first data signal receiver are positioned on a second side opposite the first side of the structural framing element.

9. The system of claim 1, further comprising a power cable coupled to supply at least some of the power transmitted through the solid medium from the first power signal receiver to the first data signal transmitter.

10. The system of claim 1, further comprising a sensor communicatively coupled to the first data signal transmitter, the sensor being configured to sense an environmental parameter and to provide the sensed environmental parameter to the first data signal transmitter coupled thereto for transmission through the solid medium to the first data signal receiver.

11. A system for transmitting power through a solid medium, the system comprising:
a power signal transmitter configured to acoustically transmit power through the solid medium to a power signal receiver; and
a controller configured to adjust an operating frequency of an ultrasonic power signal transmitted by the power signal transmitter to reduce transmission loss through the solid medium.

12. The system of claim 11, wherein the controller is configured to repeatedly adjust the operating frequency during operation of the system to maintain the operating frequency at a frequency that minimizes transmission loss through the solid medium.

13. The system of claim 11, further comprising:
a power amplifier configured to supply an electric power signal to the power signal transmitter for conversion to the ultrasonic power signal;
a circuit configured to measure a level of power drawn by the power amplifier and to provide the power level measurement to the controller,
wherein the controller is configured to adjust the operating frequency based on the power level measurement.

14. The system of claim 13, wherein the controller is configured to adjust the operating frequency if the power measurement indicates the level of power drawn is not at a minimum level.

15. The system of claim 11, wherein the controller is configured to adjust an amplitude of the transmitted ultrasonic power signal based on a level of power drawn from the power signal receiver.

16. A method for transmitting power through a solid medium, the method comprising:
transmitting an ultrasonic power signal through the solid medium;
measuring efficiency of transmission of the ultrasonic power signal frequency; and
based on the efficiency measurement, adjusting a frequency of the ultrasonic power signal transmitted through the solid medium to reduce transmission loss through the solid medium.

17. The method of claim 16, further comprising:
repeating the measurement of transmission efficiency and adjustment of the operating frequency during operation of the system to maintain the operating frequency at a frequency that minimizes transmission loss through the solid medium.

18. The method of claim 16, wherein measuring efficiency of the ultrasonic power signal frequency includes measuring a level of power drawn by a power amplifier that drives transmission of the ultrasonic power signal.

19. The method of claim 18, further comprising:
adjusting the operating frequency if the power measurement indicates the level of power drawn is not at a minimum level.

20. The method of claim 16, further comprising:
adjusting an amplitude of the transmitted ultrasonic power signal based on a level of power drawn from a power signal receiver that receives the ultrasonic power signal.
